(19) United States
(12) Patent Application Publication
(10) Pub. No.: US 2025/0156940 A1
(43) Pub. Date: May 15, 2025

(54) Technologies for Efficient Detection of Money Laundering

(71) Applicant: The PNC Financial Services Group, Inc., Pittsburgh, PA (US)

(72) Inventors: Jacob Harold Schoifet, New York, NY (US); Amanda McCracken, Westerville, OH (US); Richard Abbott Hamilton, JR., Pepper Pike, OH (US)

(21) Appl. No.: 18/939,870

(22) Filed: Nov. 7, 2024

Related U.S. Application Data
(60) Provisional application No. 63/597,737, filed on Nov. 10, 2023.

(51) Int. Cl. G06Q 40/02

(52) U.S. Cl. CPC G06Q 40/02

(57) ABSTRACT

Technologies for efficient detection of money laundering include a compute device. The compute device includes circuitry configured to obtain financial account data pertaining to multiple individuals. The circuitry is also configured to define a coordinate space in which to map the individuals associated with the obtained data, including performing a dimensionality reduction on the obtained data, map each individual according to the coordinate space, define one or more centroids in the coordinate space as a function of features of individuals previously flagged as having a defined characteristic, and flag each mapped individual that satisfies a distance threshold from a corresponding centroid in the coordinate space or that is within a defined number of closest individuals to the corresponding centroid as having the defined characteristic.

### RELATED APPLICATIONS

This application claims the benefit of U.S. Provisional Application Ser. No. 63/597,737 filed Nov. 10, 2023 for “Technologies for Efficient Detection of Money Laundering,” which is hereby incorporated by reference in its entirety.

### BACKGROUND

Financial institutions operate in an environment that is subject to strict regulatory scrutiny. One such area of intense regulation is the prevention of money laundering. A financial institution that fails to satisfy applicable anti-money laundering standards may be exposed to fines that can reach into the billions of dollars. As such, it is incumbent upon financial institutions to expend resources to perform ongoing analysis of financial records to detect suspicious activities that may be indicative of money laundering efforts and notify government authorities of such findings. However, known techniques for analyzing financial data for activities indicative of money laundering are computationally expensive (e.g., in terms of energy, time, and computer hardware) and data intensive (e.g., requiring thousands of different examples of suspicious behavior to develop a model). As such, known techniques for detecting money laundering present a dilemma between incurring inordinate costs to perform detection or having diminished money laundering detection capabilities.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for providing efficient detection of money laundering;

FIG. 2 is a simplified block diagram of at least one embodiment of a compute device of the system of FIG. 1;

FIGS. 3-5 are simplified block diagrams of at least one embodiment of a method for efficiently detecting money laundering that may be performed by the system of FIG. 1;

FIG. 6 is a simplified diagram of a dimensionality reduction operation that may be performed by the system of FIG. 1;

FIG. 7 is a diagram of a neighborhood of individuals mapped to a coordinate space based on data obtained by the system of FIG. 1 and individuals within a threshold distance of a centroid; and

FIG. 8 is a diagram of multiple centroids and individuals within distance thresholds of the corresponding centroids for each node in a set of nodes.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

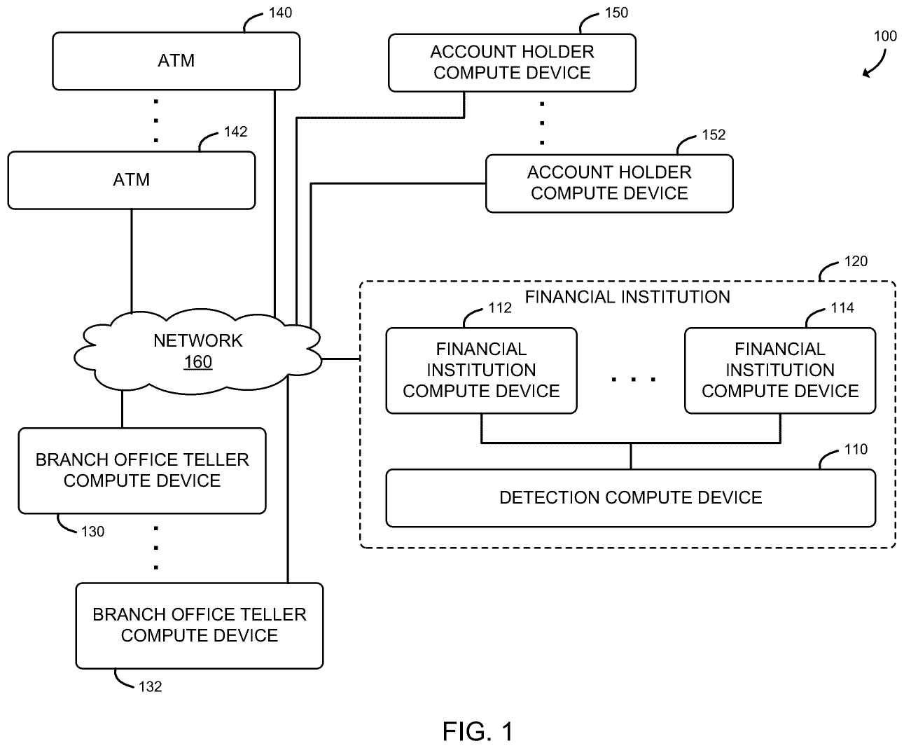

Referring now to FIG. 1, a system 100 for providing efficient detection of money laundering includes, in the illustrative embodiment, a detection compute device 110 that is communicatively connected to a set of financial institution compute devices 112, 114. The financial institution compute devices 112, 114 process financial transactions on behalf of account holders (e.g., customers) of a financial institution 120 (e.g., a bank). The compute devices 110, 112, 114 may be located in a data center (e.g., a facility housing compute devices, thermal control equipment, power management equipment, and networking equipment to support the operations of the compute devices). A set of branch office teller compute devices 130, 132 may communicate with the compute devices 110, 112, 114 of the financial institution to send and receive data pertaining to transactions (e.g., deposits, withdrawal, money transfers, establishment of new account(s), etc.) initiated at branch offices of the financial institution. Likewise, a set of automated teller machines 140, 142, which may be located at branch offices and/or at other locations (e.g., gas stations, street corners, etc.) are also communicatively connected to one or more of the compute devices 110, 112, 114 of the financial institution 120 to send and receive financial transaction data. The system 100, in the illustrative embodiment, additionally includes account holder compute devices 150, 152, (e.g., personal computers, notebook computers, tablets, smart phones, etc.), through which account holders may conduct financial transactions (e.g., through communication with one or more compute devices 110, 112, 114 of the financial institution 120 or other compute devices (e.g., e-commerce platforms, etc.)).

In operation, the detection compute device 110 obtains financial account data (e.g., from one or more databases maintained by the financial institution compute devices 112, 114) for detection of money laundering activity. In doing so, the detection compute device 110 may receive a data set with a vast amount of variables or features (e.g., dimensions of data) and, in the illustrative embodiment, performs a dimensionality reduction on the obtained financial account data to reduce the computational burden, while still preserving critical information. More specifically, in some embodiments, the detection compute device 110 performs a principal component analysis and reduces the number of features. In some embodiments, the detection compute device 110 may reduce the number of features by approximately 50% (e.g., from 700 features to 350 features), keeping the features that account for the majority of the variation between individuals represented in the obtained data. Further, to improve the performance of the detection compute device 110, the detection compute device 110 may perform a reverse version of a K-nearest neighbor (KNN) clustering process. Money laundering activity makes up a relatively small percentage of all financial transaction activity. As such, the traditional KNN approach encounters difficulty identifying money launderers given that traditional KNN is determined by a majority vote of close neighbors. In performing the modified form of KNN, rather than identifying clusters of individuals mapped in the coordinate space, then investigating whether those clusters represent a common activity, the detection compute device 110 instead places centroids in the coordinate space based on features of individuals that have been previously confirmed as money launderers and then identifies (e.g., flags), as suspected money launderers, other individuals that have not yet been identified as money launderers but are within a distance threshold of a given centroid. In performing these operations, the detection compute device 110 vastly improves the efficiency and accuracy of detection over conventional approaches, and may be used to detect money launderers that may have been missed by less effective detection models.

While a single detection compute device 110, two financial institution compute devices 112, 114, two branch office teller compute devices 130, 132, two ATMs 140, 142, and two account holder compute devices 150, 152 are shown for simplicity and clarity, it should be understood that the number of compute devices, in practice, may range in the tens, hundreds, thousands, or more. Likewise, it should be understood that the compute devices 110, 112, 114, 130, 132, 140, 142, 150, 152 may be distributed differently or perform different roles than the configuration shown in FIG. 1. Further, though shown as separate compute devices 110, 112, 114, 130, 132, 140, 142, 150, 152 in some embodiments, the functionality of one or more of the compute devices 110, 112, 114, 130, 132, 140, 142, 150, 152 may be combined into fewer compute devices and/or distributed across more compute devices than those shown in FIG. 1.

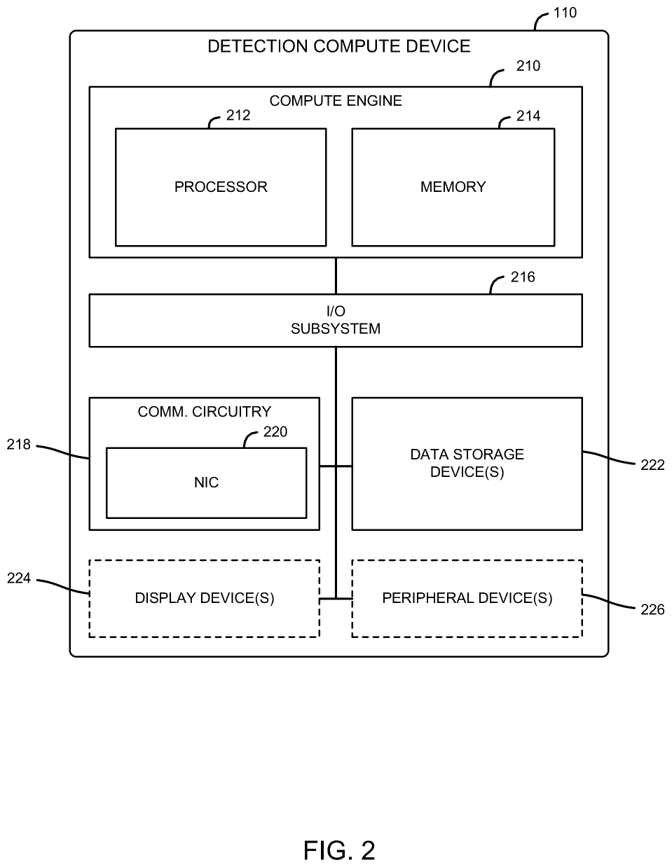

Referring now to FIG. 2, the illustrative detection compute device 110 includes a compute engine 210, an input/output (I/O) subsystem 216, communication circuitry 218, and one or more data storage devices 222. In some embodiments, the detection compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the detection compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as database records, applications, libraries, and drivers.

The compute engine 210 is communicatively coupled to other components of the detection compute device 110 via the I/O subsystem 216, which may be embodied as circuitry and/or components to facilitate input/output operations with the compute engine 210 (e.g., with the processor 212 and the main memory 214) and other components of the detection compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the detection compute device 110, into the compute engine 210.

The communication circuitry 218 may be embodied as any communication circuit, device, or collection thereof, capable of enabling communications over a network between the detection compute device 110 and another device (e.g., a compute device 112, 114, 130, 132, 140, 142, 150, 152, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the detection compute device 110 to connect with another compute device (e.g., a compute device 112, 114, 130, 132, 140, 142, 150, 152, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the detection compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the detection compute device 110 are housed in a single unit. However, in other embodiments, the components may be in separate housings, in separate racks of a data center, and/or spread across multiple data centers or other facilities. The compute devices 112, 114, 130, 132, 140, 142, 150, 152 may have components similar to those described in FIG. 2 with reference to the detection compute device 110. The description of those components of the detection compute device 110 is equally applicable to the description of components of the compute devices 112, 114, 130, 132, 140, 142, 150, 152. Further, it should be appreciated that any of the devices 112, 114, 130, 132, 140, 142, 150, 152 may include other components, sub-components, and devices commonly found in a computing device, which are not discussed above in reference to the detection compute device 110 and not discussed herein for clarity of the description.

In the illustrative embodiment, the compute devices 110, 112, 114, 130, 132, 140, 142, 150, 152 are in communication via a network 160, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

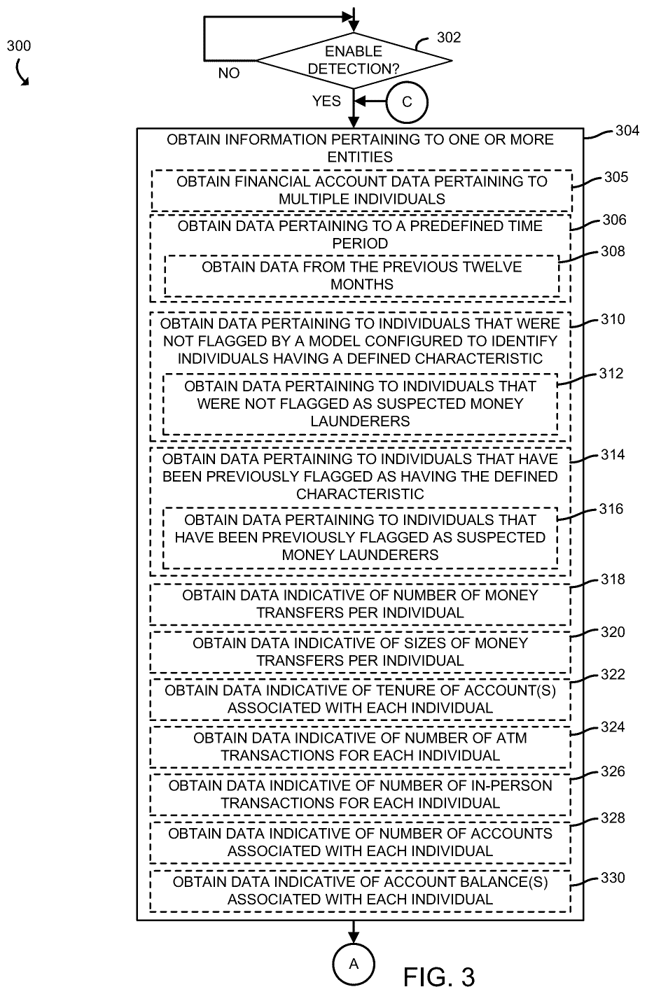

Referring now to FIG. 3, the system 100, and more specifically, the detection compute device 110, in the illustrative embodiment, may perform a method 300 for providing efficient detection of money laundering. The method 300 begins with block 302 in which the detection compute device 110 determines whether to enable efficient detection (e.g., of money laundering). In doing so, the detection compute device 110 may determine to enable efficient detection in response to a determination that a configuration setting (e.g., in memory 214 or in storage 222) indicates to enable efficient detection, in response to receiving a request from another compute device to enable efficient detection, and/or based on other factors. Regardless, in response to a determination to enable efficient detection, the method 300 advances to block 304 in which the detection compute device 110 obtains information pertaining to one or more entities. As indicated in block 305, in at least some embodiments, the detection compute device 110 obtains financial account data pertaining to multiple individuals (e.g., from people holding financial accounts with the financial institution 120). In doing so, and as indicated in block 306, the detection compute device 110 obtains data pertaining to a predefined time period. In the illustrative embodiment, the detection compute device 110 obtains data from the previous twelve month period, as indicated in block 308.

As indicated in block 310, the detection compute device 110 obtains data pertaining to individuals that were not flagged by a model configured to identify individuals having a defined characteristic. In the illustrative embodiment, the detection compute device 110 obtains data pertaining to individuals that were not flagged as suspected money launderers, as indicated in block 312. That is, in the illustrative embodiment, the detection compute device 110 executes the method 300 after at least a portion of the financial account data has already been analyzed at least once (e.g., by a different model having a different architecture, an earlier execution of the method 300 based on data from a different time period, etc.), and one or more individuals passed through the earlier analysis without being identified as money launderers (e.g., those individuals were “below the line (BTL)”).

The detection compute device 110 also obtains data indicative of individuals that have been previously flagged as having the defined characteristic, as indicated in block 314. In the illustrative embodiment, the detection compute device 110 obtains data pertaining to individuals that have been previously flagged as suspected money launderers (e.g., individuals referred to as “persons of interest” or “production value alerts (PVAs)”), as indicated in block 316. Those individuals may have been identified initially by an automated process, such as by an earlier iteration of the method 300 or by another model, and may be referred to as being “above the line (ATL).” In other instances, one or more individuals may be manually identified as money launderers and may be referred to as “do not risk accept alert (DNRA).” In block 318, the detection compute device 110 may obtain data indicative of the number of money transfers per individual represented in the obtained data (e.g., a frequency of money transfers for each individual). Additionally, the detection compute device 110 may obtain data indicative of sizes of money transfers for each individual (e.g., the average amount of dollars involved in the money transfers for each individual), as indicated in block 320. The detection compute device 110 may obtain data indicative of a tenure (e.g., age) of the financial account(s) held by each individual represented in the obtained data, as indicated in block 322.

The detection compute device 110 may also obtain data indicated of the number of transactions performed at an ATM 140, 142 by each individual represented in the obtained data, as indicated in block 324. Further, the detection compute device 110 may obtain data indicative of the number of in-person (e.g., through interaction with a teller at a branch office of the financial institution 120) transactions for each individual represented in the data, as indicated in block 326. The detection compute device 110 may also obtain data indicative of the number of financial accounts associated with each individual, as indicated in block 328. Further, and as indicated in block 330, the detection compute device 110 may also obtain data indicative of account balances associated with each individual. In some embodiments, the detection compute device 110 may obtain data indicative of distances between bank branches, whether an individual or entity is on a watch list, and/or negative news (e.g., an indication of a criminal history associated with one or more individuals).

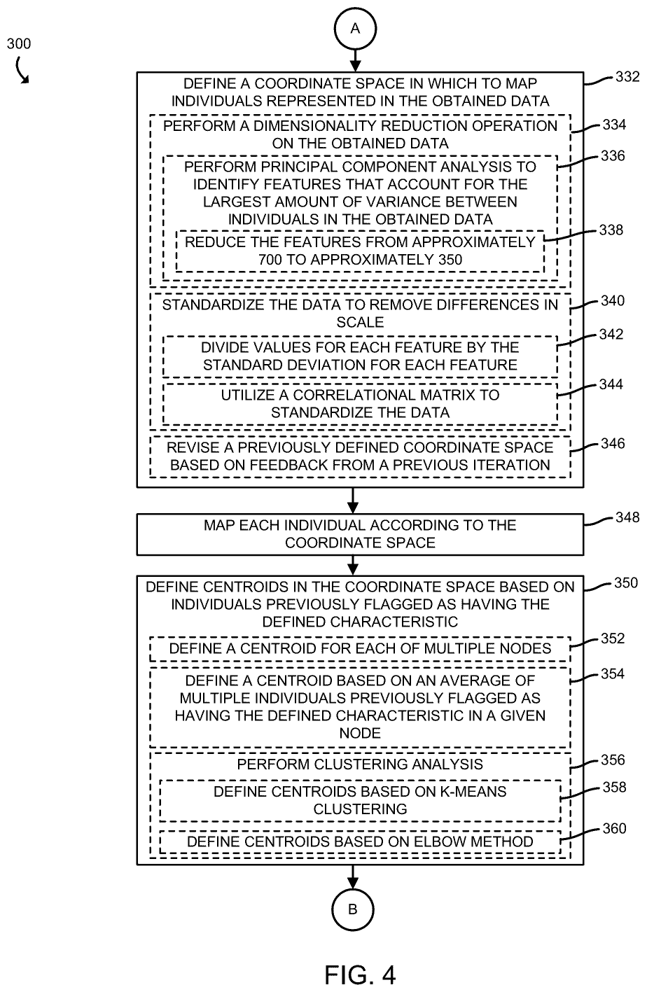

Referring now to FIG. 4, in continuing the method 300, the detection compute device 110 defines a coordinate space in which to map the individuals represented in the obtained data (e.g., from block 304), as indicated in block 332. In doing so, and as indicated in block 334, the detection compute device 110, in the illustrative embodiment, performs a dimensionality (e.g., variable, feature, etc.) reduction operation on the obtained data. The detection compute device 110 in the illustrative embodiment does so by performing a principal component analysis to identify features (e.g., variables) that account for the largest amount of variance between individuals in the obtained data, as indicated in block 336. In performing the principal component analysis, the detection compute device 110 produces a set of orthogonal columns of principal components (i.e., Eigenvectors) that are linear combinations of the original set of features or variables from the data obtained in block 304. Further, in doing so, the detection compute device 110 obtains an ordered set of Eigenvalues, representing, in descending order, the amount of variance that each Eigenvector (e.g., principal component, linear combination, etc.) represents or accounts for. The principal component analysis is represented by Equation 1 below, in which V represents Eigenvectors of covariance matrix of X and X represents a dataset of interest:

P=XV (Equation 1).

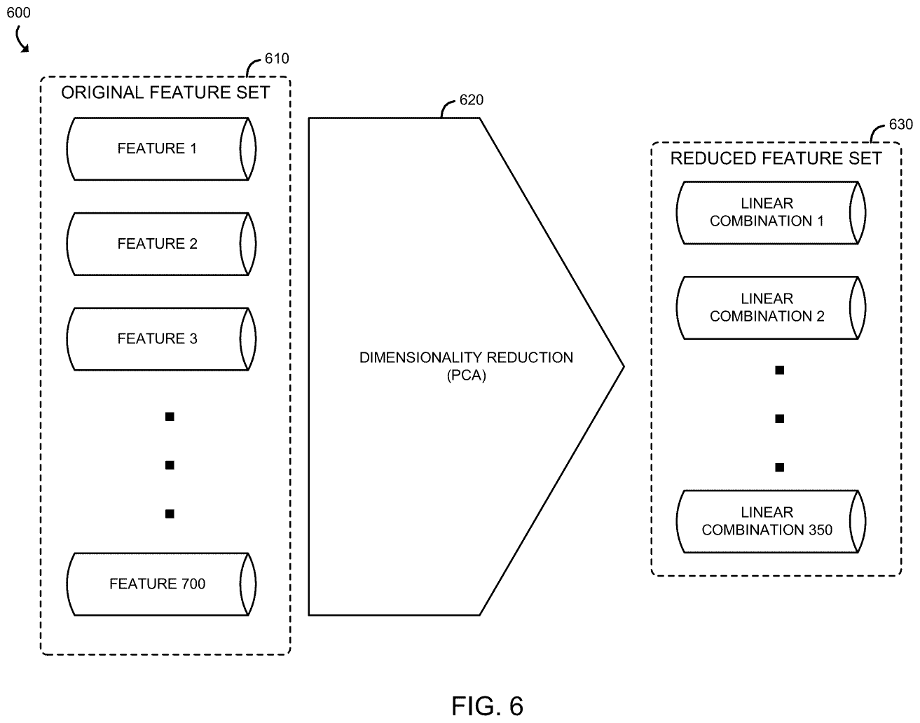

By favoring the earlier principal components in the set and disregarding later ones, the detection compute device 110 preserves the majority of the information used to separate one individual from another in the coordinate space while drastically reducing the computational resources that would otherwise be required to perform a mapping of the individuals based on all of the variables (features) in the obtained data. In the illustrative embodiment, the detection compute device 110 reduces the set of features by approximately 50% or from approximately 700 features to approximately 350 features, as indicated in block 338. A representation of the dimensionality reduction is shown in the diagram 600 of FIG. 6. As shown, the detection compute device 110 obtains an original feature set 610 of approximately 700 features in the financial account data obtained in block 304 of the method 300 (e.g., variables, such as tenure of a financial account, number of money transfers per month, average size of money transfers, etc.). Subsequently, the detection compute device 110 performs a dimensionality reduction 620, such as principal component analysis, on the original feature set to produce a set 630 of linear combinations (also referred to as principal components) of features that explain or account for the most variance between individuals represented in the original feature set 610. As shown, the set 630 is approximately half the size of the original feature set 610. By reducing the number of features while retaining the information that differentiates or groups individuals together, the detection compute device 110 reduces the required computational load to perform a money laundering detection analysis on the obtained financial account data from block 304.

Referring back to FIG. 4, the detection compute device 110 also standardizes the obtained data to remove differences in scale, as indicated in block 340. In doing so, the detection compute device 110 may divide values for each feature by the standard deviation of the values for that feature, as indicated in block 342. Alternatively, and as indicated in block 344, the detection compute device 110 may standardize the data using a correlational matrix, as the variance-covariance matrix divided by the product of the standard deviations is the correlation matrix. In some embodiments, the detection compute device 110 may revise a previously defined coordinate space based on feedback from a previous iteration (e.g., because a particular component or feature has increased or decreased in significance in mapping individuals in the coordinate space), as indicated in block 346.

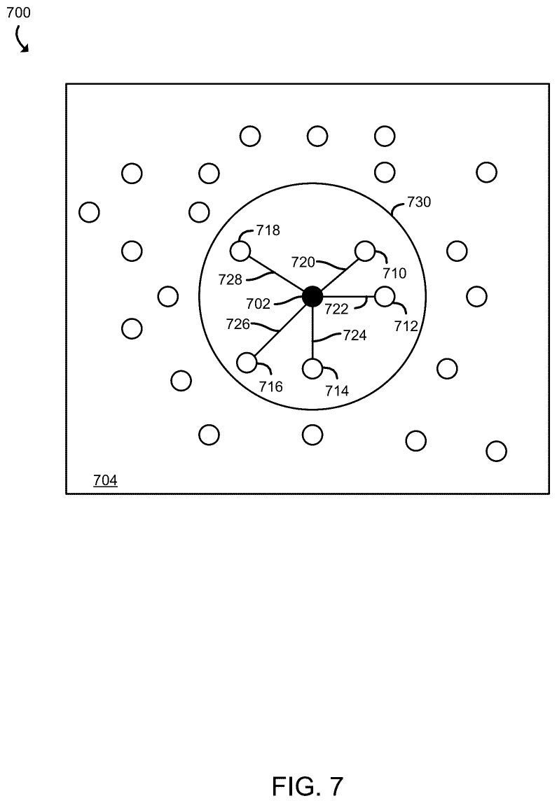

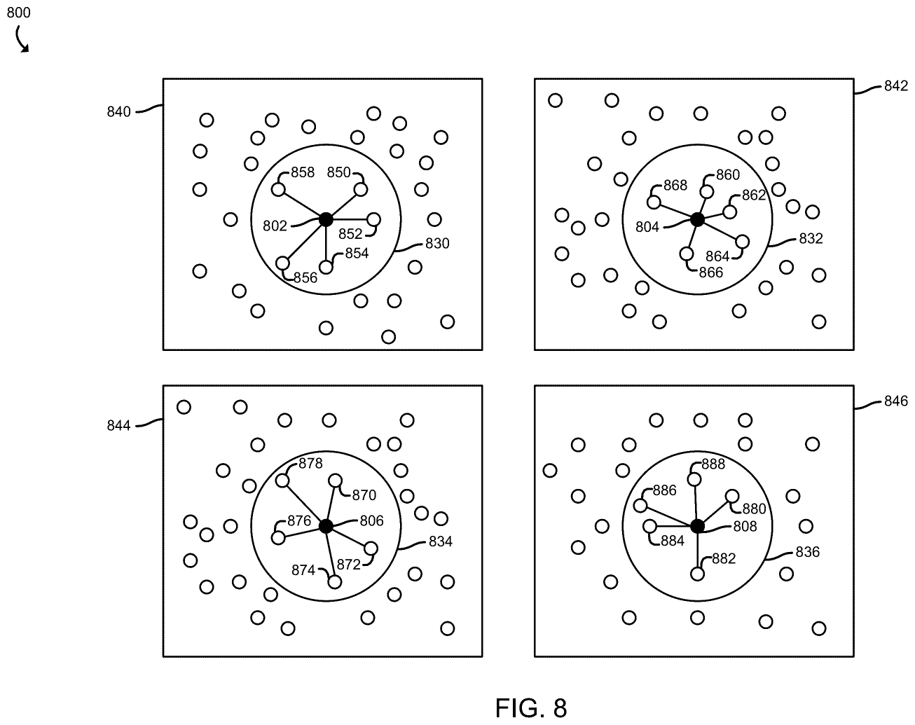

As indicated in block 348, the detection compute device 110 maps the individuals according to the coordinate space. A two-dimensional projection of such a mapping is represented in the diagram 700 of FIG. 7. Referring back to FIG. 4, in block 350, the detection compute device 110 defines one or more centroids in the coordinate space based on individuals that were previously flagged as having the defined characteristic (e.g., flagged as being suspected money launderers). In doing so, the detection compute device 110 may defined a centroid for each of multiple nodes, as indicated in block 352. Referring now to FIG. 8, a diagram 800 represents nodes, each with a corresponding centroid. Referring back to FIG. 4, the detection compute device 110 may define a centroid based on an average of multiple individuals previously flagged as having the defined characteristic in a given node (e.g., by averaging their coordinates), as indicated in block 354. In block 356, the detection compute device 110 may perform clustering analysis (e.g., to balance the number of clusters to be created and analyzed against the computational cost of doing so). In doing so, the detection compute device 110 may define the centroids based on K-means clustering as indicated in block 358. As indicated in block 360, the detection compute device 110 may utilize the elbow method in connection with the K-means clustering. That is, the detection compute device 110 may iteratively vary the number of clusters (K) produced from K-means clustering across a range of values and for each value of K, determine a sum of squared distance between each point and the centroid of the corresponding cluster. When the squared distance is plotted against K, a significant change in the curvature (e.g., an elbow or knee) appears at a particular value of K, after which (e.g., for higher values of K), the squared distance changes very little. That is, beyond that value of K, there are diminishing returns for creating and analyzing additional clusters.

The detection compute device 110 may perform a simulation strategy to determine an average distance as a baseline to compare centroids to. In the simulation strategy, the detection compute device obtains a random sample of 500 elements per segment using a set random seed that starts at 1. Next, the detection compute device 110 determines the pairwise distance between each element within a segment. 500*500=250,000 comparisons per segment is executable. Using the full segment population, by contrast, takes an exponentially larger amount of time to perform. Subsequently, the detection compute device 110 determines the average distance for each segment and stores them (e.g., in a table data structure). Afterwards, the detection compute device 110 restarts the sampling but increases the seed, giving a different random sample. The detection compute device 110 performs the above operations until it has done so with 100 different seeds. Next, the detection compute device 110 takes the different averages that were calculated, and averages them, to obtain a true average distance for each. The average distance may be used as a baseline to compare centroids to. A useful centroid should have an average distance to center than is less than the average distance for the whole segment.

In the elbow method referenced above, the detection compute device 110 may perform the following process for each segment individually. The detection compute device 110 finds the maximum number of clusters possible (e.g., the same as the number of DNRAs in the segment). Starting with K=1, the detection compute device executes a K-means clustering algorithm. This will return the best result when only one cluster is desired. Next, the detection compute device 110 stores the sum of squared differences to the center of the centroid (known as inertia). When a centroid is homogenous, it will have a lower inertia/average distance to center. To compare to the baseline property, the detection compute device 110 utilizes the average distance to the closest centroid for graphing. The detection compute device 110 executes the above operations for K=1 to N−1. Distortion is 0 when K=N, since every DNRA is its own centroid. Subsequently, the detection compute device 110 graphs the distance/distortion on the y axis and the value of K on the x axis, and visually analyzes the graph to identify the elbow.

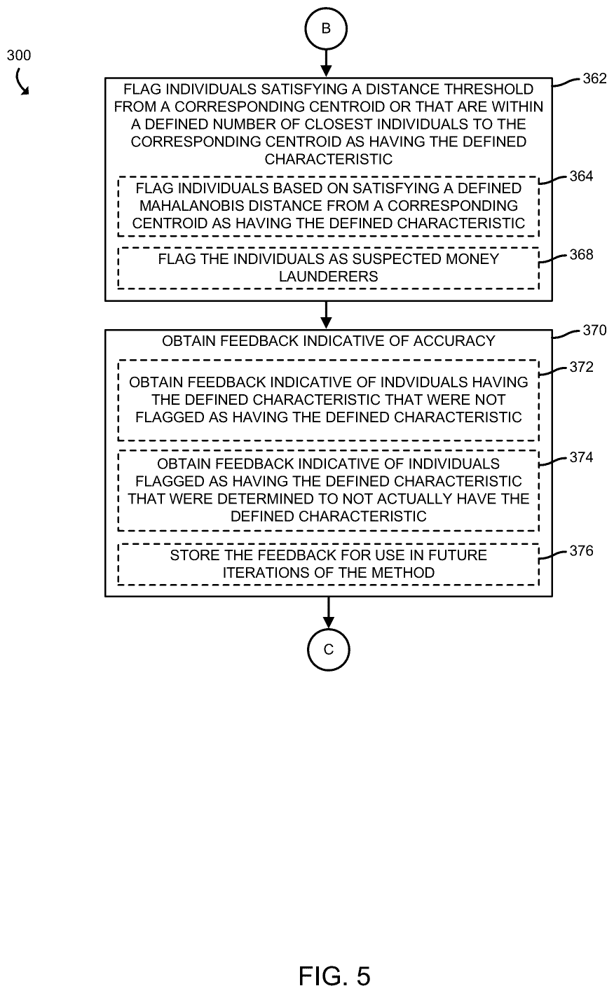

Referring now to FIG. 5, in block 362, the detection compute device 110 flags individuals satisfying a distance threshold from a corresponding centroid or that are within a defined number of closest individuals (e.g., the five nearest neighbors) to the corresponding centroid as having the defined characteristic. In doing so, and as indicated in block 364, the detection compute device 110 may flag individuals based on satisfying a defined Mahalanobis distance from a corresponding centroid as having the defined characteristic. The Mahalanobis distance is a multivariate distance metric that measures the distance between a point and a distribution. In flagging individuals as having a defined characteristic, the detection compute device 110, in the illustrative embodiment, flags the individuals as suspected money launderers, as indicated in block 368. In the illustrative embodiment, the detection compute device 110 performs the operation associated with block 362 for each centroid that was defined in block 350.

Referring to the diagram 700 in FIG. 7, a centroid 702 is defined in the coordinate space as described above with reference to block 350 of the method. The centroid 702 may be based on a single individual known to have the defined characteristic (e.g., a single suspected money launderer) or may be based on an average of multiple such individuals (e.g., multiple suspected money launderers). Around the centroid 702 is a neighborhood 704 of other individuals that the detection compute device 110 has mapped in the coordinate space, based on their respective features. Each of five individuals 710, 712, 714, 716, 718 are separated from the centroid 702 by a corresponding distance (Mahalanobis distance) 720, 722, 724, 726, 728 that satisfies (e.g., is within) a distance threshold 730. The distance threshold 730 may be fixed (e.g., a predefined Mahalanobis distance) or may be adaptively adjusted to contain a threshold number (e.g., five) of individuals nearest to the centroid 702. As shown in the diagram 800 of FIG. 8, the detection compute device 110 identifies the nearest neighbors 850, 852, 854, 856, 858, 860, 862, 864, 866, 868, 870, 872, 874, 876, 878, 880, 882, 884, 886, 888 (e.g., within the corresponding distance threshold 830, 832, 834, 836) for each centroid 802, 804, 806, 808 (e.g., defined for each node 840, 842, 844, 846 (e.g., leaf nodes of a tree structure)) in a coordinate space.

The detection compute device 110 may obtain feedback indicative of the accuracy of the detection (e.g., flagging) of individuals as having the defined characteristic (e.g., as suspected money launderers), as indicated in block 370. The feedback may be produced based on investigation (e.g., by human investigators, etc.) into individuals flagged as having the defined characteristic or based on other sources (e.g., a database of individuals known to have the defined characteristic (e.g., known money launderers)). In obtaining the feedback, the detection compute device 110 may obtain feedback indicative of individuals having the defined characteristic that were not flagged by the detection compute device 110 as having the defined characteristic (e.g., below the line (BTL) product value alerts (PVAs)), as indicated in block 372. As indicated in block 374, the detection compute device 110 may obtain feedback indicative of individuals flagged (e.g., by the detection compute device 110) as having the defined characteristic that were determined to not actually have the defined characteristic (e.g., false positives). The detection compute device 110 may store the obtained feedback for use in later iterations of the method 300 (e.g., for use in determining the locations of centroids), as indicated in block 376. Subsequently, the method 300 loops back to block 304 to collect additional financial account data and iterate through the operations of the method 300 again. Though the operations of the method 300 are presented above in a particular order, it should be understood that one or more of the operations could be performed in a different order and/or concurrently. Further, while the operations are described in connection with identifying potential money launderers, it will be appreciated by those skilled in the art, in light of this disclosure, that the operations could be readily applied to the detection of other entities of interest.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain financial account data pertaining to multiple individuals; define a coordinate space in which to map the individuals associated with the obtained data, including performing a dimensionality reduction on the obtained data; map each individual according to the coordinate space; define one or more centroids in the coordinate space as a function of features of individuals previously flagged as having a defined characteristic; and flag each mapped individual that satisfies a distance threshold from a corresponding centroid in the coordinate space or that is within a defined number of closest individuals to the corresponding centroid as having the defined characteristic.

Example 2 includes the subject matter of Example 1, and wherein to perform a dimensionality reduction on the obtained data comprises to perform a principal component analysis to identify features that account for the largest amount of variance between individuals in the obtained data.

Example 3 includes the subject matter of any of Examples 1 and 2, and wherein to perform a dimensionality reduction comprises to reduce the features from approximately 700 features to approximately 350 features.

Example 4 includes the subject matter of any of Examples 1-3, and wherein to flag each mapped individual that satisfies a distance threshold from a corresponding centroid comprises to flag each mapped individual satisfying the distance threshold as a suspected money launderer.

Example 5 includes the subject matter of any of Examples 1-4, and wherein the circuitry is further configured to standardize the obtained data to remove differences in scale.

Example 6 includes the subject matter of any of Examples 1-5, and wherein to standardize the obtained data comprises to divide values represented in the obtained data for each feature by a standard deviation for each feature.

Example 7 includes the subject matter of any of Examples 1-6, and wherein to standardize the obtained data comprises to standardize the data with a correlational matrix.

Example 8 includes the subject matter of any of Examples 1-7, and wherein to define one or more centroids comprises to define a centroid for each of multiple nodes.

Example 9 includes the subject matter of any of Examples 1-8, and wherein to define one or more centroids comprises to define a centroid based on an average of multiple individuals previously flagged as having the defined characteristic.

Example 10 includes the subject matter of any of Examples 1-9, and wherein to obtain financial account data comprises to obtain data pertaining to individuals that were not flagged by a model configured to identify individuals having the defined characteristic.

Example 11 includes the subject matter of any of Examples 1-10, and wherein to obtain data pertaining to individuals that were not flagged by the model comprises to obtain data pertaining to individuals that were not flagged as suspected money launderers.

Example 12 includes the subject matter of any of Examples 1-11, and wherein to obtain financial account data comprises to obtain data pertaining to individuals that were previously flagged as having the defined characteristic.

Example 13 includes the subject matter of any of Examples 1-12, and wherein to obtain data pertaining to individuals that were flagged as having the defined characteristic comprises to obtain data pertaining to individuals that were previously flagged as suspected money launderers.

Example 14 includes the subject matter of any of Examples 1-13, and wherein to obtain financial account data comprises to obtain data pertaining to a predefined time period.

Example 15 includes the subject matter of any of Examples 1-14, and wherein to obtain financial account data comprises to obtain data pertaining to a period of twelve months.

Example 16 includes the subject matter of any of Examples 1-15, and wherein to obtain data comprises to obtain data indicative of a number of money transfers performed for each individual.

Example 17 includes the subject matter of any of Examples 1-16, and wherein to obtain data comprises to obtain data indicative of sizes of money transfers performed for each individual.

Example 18 includes the subject matter of any of Examples 1-17, and wherein to obtain data comprises to obtain data indicative of a tenure of one or more accounts of each individual.

Example 19 includes the subject matter of any of Examples 1-18, and wherein to obtain data comprises to obtain data indicative of a number of automated teller machine transactions performed for each individual.

Example 20 includes the subject matter of any of Examples 1-19, and wherein to obtain data comprises to obtain data indicative of a number of in-person transactions performed for each individual.

Example 21 includes the subject matter of any of Examples 1-20, and wherein to obtain data comprises to obtain data indicative of an account balance associated with each individual.

Example 22 includes the subject matter of any of Examples 1-21, and wherein to obtain data comprises to obtain data indicative of a number of accounts associated with each individual.

Example 23 includes the subject matter of any of Examples 1-22, and wherein the circuitry is further configured to perform a clustering analysis for each centroid.

Example 24 includes the subject matter of any of Examples 1-23, and wherein to perform a clustering analysis comprises to perform k-means clustering.

Example 25 includes the subject matter of any of Examples 1-24, and wherein the circuitry is further configured to perform an analysis to identify an elbow in a curve charted based on a number of clusters versus a percentage of variance accounted for by the clusters.

Example 26 includes the subject matter of any of Examples 1-25, and wherein to flag each mapped individual that satisfies a distance threshold from a corresponding centroid comprises to flag each mapped individual satisfying a defined Mahalanobis distance from the corresponding centroid.

Example 27 includes the subject matter of any of Examples 1-26, and wherein the circuitry is further to obtain feedback indicative of an accuracy of the compute device; and store the feedback for future identification of individuals having the defined characteristic.

Example 28 includes the subject matter of any of Examples 1-27, and wherein to obtain feedback comprises to obtain feedback indicative of individuals having the defined characteristic that were not flagged by the compute device as having the defined characteristic.

Example 29 includes the subject matter of any of Examples 1-28, and wherein to obtain feedback comprises to obtain feedback indicative of individuals that were flagged by the compute device as having the defined characteristic and that were later determined to not actually have the defined characteristic.

Example 30 includes a method comprising obtaining, by a compute device, financial account data pertaining to multiple individuals; defining, by the compute device, a coordinate space in which to map the individuals associated with the obtained data, including performing a dimensionality reduction on the obtained data; mapping, by the compute device, each individual according to the coordinate space; defining, by the compute device, one or more centroids in the coordinate space as a function of features of individuals previously flagged as having a defined characteristic; and flagging, by the compute device, each mapped individual that satisfies a distance threshold from a corresponding centroid in the coordinate space or that is within a defined number of closest individuals to the corresponding centroid as having the defined characteristic.

Example 31 includes the subject matter of Example 30, and wherein performing a dimensionality reduction on the obtained data comprises performing a principal component analysis to identify features that account for the largest amount of variance between individuals in the obtained data.

Example 32 includes the subject matter of any of Examples 30 and 31, and wherein performing a dimensionality reduction comprises reducing the features from approximately 700 features to approximately 350 features.

Example 33 includes the subject matter of any of Examples 30-32, and wherein flagging each mapped individual that satisfies a distance threshold from a corresponding centroid comprises flagging each mapped individual satisfying the distance threshold as a suspected money launderer.

Example 34 includes the subject matter of any of Examples 30-33, and further including standardizing, by the compute device, the obtained data to remove differences in scale.

Example 35 includes the subject matter of any of Examples 30-34, and wherein standardizing the obtained data comprises dividing values represented in the obtained data for each feature by a standard deviation for each feature.

Example 36 includes the subject matter of any of Examples 30-35, and wherein standardizing the obtained data comprises standardizing the data with a correlational matrix.

Example 37 includes the subject matter of any of Examples 30-36, and wherein defining one or more centroids comprises defining a centroid for each of multiple nodes.

Example 38 includes the subject matter of any of Examples 30-37, and wherein defining one or more centroids comprises defining a centroid based on an average of multiple individuals previously flagged as having the defined characteristic.

Example 39 includes the subject matter of any of Examples 30-38, and wherein obtaining financial account data comprises obtaining data pertaining to individuals that were not flagged by a model configured to identify individuals having the defined characteristic.

Example 40 includes the subject matter of any of Examples 30-39, and wherein obtaining data pertaining to individuals that were not flagged by the model comprises obtaining data pertaining to individuals that were not flagged as suspected money launderers.

Example 41 includes the subject matter of any of Examples 30-40, and wherein obtaining financial account data comprises obtaining data pertaining to individuals that were previously flagged as having the defined characteristic.

Example 42 includes the subject matter of any of Examples 30-41, and wherein obtaining data pertaining to individuals that were flagged as having the defined characteristic comprises obtaining data pertaining to individuals that were previously flagged as suspected money launderers.

Example 43 includes the subject matter of any of Examples 30-42, and wherein obtaining financial account data comprises obtaining data pertaining to a predefined time period.

Example 44 includes the subject matter of any of Examples 30-43, and wherein obtaining financial account data comprises obtaining data pertaining to a period of twelve months.

Example 45 includes the subject matter of any of Examples 30-44, and wherein obtaining data comprises obtaining data indicative of a number of money transfers performed for each individual.

Example 46 includes the subject matter of any of Examples 30-45, and wherein obtaining data comprises obtaining data indicative of sizes of money transfers performed for each individual.

Example 47 includes the subject matter of any of Examples 30-46, and wherein obtaining data comprises obtaining data indicative of a tenure of one or more accounts of each individual.

Example 48 includes the subject matter of any of Examples 30-47, and wherein obtaining data comprises obtaining data indicative of a number of automated teller machine transactions performed for each individual.

Example 49 includes the subject matter of any of Examples 30-48, and wherein obtaining data comprises obtaining data indicative of a number of in-person transactions performed for each individual.

Example 50 includes the subject matter of any of Examples 30-49, and wherein obtaining data comprises obtaining data indicative of an account balance associated with each individual.

Example 51 includes the subject matter of any of Examples 30-50, and wherein obtaining data comprises obtaining data indicative of a number of accounts associated with each individual.

Example 52 includes the subject matter of any of Examples 30-51, and further including performing, by the compute device, a clustering analysis for each centroid.

Example 53 includes the subject matter of any of Examples 30-52, and wherein performing a clustering analysis comprises perform k-means clustering.

Example 54 includes the subject matter of any of Examples 30-53, and further including performing an analysis to identify an elbow in a curve charted based on a number of clusters versus a percentage of variance accounted for by the clusters.

Example 55 includes the subject matter of any of Examples 30-54, and wherein flagging each mapped individual that satisfies a distance threshold from a corresponding centroid comprises flagging each mapped individual satisfying a defined Mahalanobis distance from the corresponding centroid.

Example 56 includes the subject matter of any of Examples 30-55, and further including obtaining, by the compute device, feedback indicative of an accuracy of the compute device; and storing, by the compute device, the feedback for future identification of individuals having the defined characteristic.

Example 57 includes the subject matter of any of Examples 30-56, and wherein obtaining feedback comprises obtaining feedback indicative of individuals having the defined characteristic that were not flagged by the compute device as having the defined characteristic.

Example 58 includes the subject matter of any of Examples 30-57, and wherein obtaining feedback comprises obtaining feedback indicative of individuals that were flagged by the compute device as having the defined characteristic and that were later determined to not actually have the defined characteristic.

Example 59 includes one or more machine-readable storage media comprising a plurality of instructions stored thereon that, in response to being executed, cause a compute device to obtain financial account data pertaining to multiple individuals; define a coordinate space in which to map the individuals associated with the obtained data, including performing a dimensionality reduction on the obtained data; map each individual according to the coordinate space; define one or more centroids in the coordinate space as a function of features of individuals previously flagged as having a defined characteristic; and flag each mapped individual that satisfies a distance threshold from a corresponding centroid in the coordinate space or that is within a defined number of closest individuals to the corresponding centroid as having the defined characteristic.

Example 60 includes the subject matter of Example 59, and wherein to perform a dimensionality reduction on the obtained data comprises to perform a principal component analysis to identify features that account for the largest amount of variance between individuals in the obtained data.

Example 61 includes the subject matter of any of Examples 59 and 60, and wherein to perform a dimensionality reduction comprises to reduce the features from approximately 700 features to approximately 350 features.

Example 62 includes the subject matter of any of Examples 59-61, and wherein to flag each mapped individual that satisfies a distance threshold from a corresponding centroid comprises to flag each mapped individual satisfying the distance threshold as a suspected money launderer.

Example 63 includes the subject matter of any of Examples 59-62, and wherein the instructions further cause the compute device to standardize the obtained data to remove differences in scale.

Example 64 includes the subject matter of any of Examples 59-63, and wherein to standardize the obtained data comprises to divide values represented in the obtained data for each feature by a standard deviation for each feature.

Example 65 includes the subject matter of any of Examples 59-64, and wherein to standardize the obtained data comprises to standardize the data with a correlational matrix.

Example 66 includes the subject matter of any of Examples 59-65, and wherein to define one or more centroids comprises to define a centroid for each of multiple nodes.

Example 67 includes the subject matter of any of Examples 59-66, and wherein to define one or more centroids comprises to define a centroid based on an average of multiple individuals previously flagged as having the defined characteristic.

Example 68 includes the subject matter of any of Examples 59-67, and wherein to obtain financial account data comprises to obtain data pertaining to individuals that were not flagged by a model configured to identify individuals having the defined characteristic.

Example 69 includes the subject matter of any of Examples 59-68, and wherein to obtain data pertaining to individuals that were not flagged by the model comprises to obtain data pertaining to individuals that were not flagged as suspected money launderers.

Example 70 includes the subject matter of any of Examples 59-69, and wherein to obtain financial account data comprises to obtain data pertaining to individuals that were previously flagged as having the defined characteristic.

Example 71 includes the subject matter of any of Examples 59-70, and wherein to obtain data pertaining to individuals that were flagged as having the defined characteristic comprises to obtain data pertaining to individuals that were previously flagged as suspected money launderers.

Example 72 includes the subject matter of any of Examples 59-71, and wherein to obtain financial account data comprises to obtain data pertaining to a predefined time period.

Example 73 includes the subject matter of any of Examples 59-72, and wherein to obtain financial account data comprises to obtain data pertaining to a period of twelve months.

Example 74 includes the subject matter of any of Examples 59-73, and wherein to obtain data comprises to obtain data indicative of a number of money transfers performed for each individual.

Example 75 includes the subject matter of any of Examples 59-74, and wherein to obtain data comprises to obtain data indicative of sizes of money transfers performed for each individual.

Example 76 includes the subject matter of any of Examples 59-75, and wherein to obtain data comprises to obtain data indicative of a tenure of one or more accounts of each individual.

Example 77 includes the subject matter of any of Examples 59-76, and wherein to obtain data comprises to obtain data indicative of a number of automated teller machine transactions performed for each individual.

Example 78 includes the subject matter of any of Examples 59-77, and wherein to obtain data comprises to obtain data indicative of a number of in-person transactions performed for each individual.

Example 79 includes the subject matter of any of Examples 59-78, and wherein to obtain data comprises to obtain data indicative of an account balance associated with each individual.

Example 80 includes the subject matter of any of Examples 59-79, and wherein to obtain data comprises to obtain data indicative of a number of accounts associated with each individual.

Example 81 includes the subject matter of any of Examples 59-80, and wherein the instructions further cause the compute device to perform a clustering analysis for each centroid.

Example 82 includes the subject matter of any of Examples 59-81, and wherein to perform a clustering analysis comprises to perform k-means clustering.

Example 83 includes the subject matter of any of Examples 59-82, and wherein the instructions additionally cause the compute device to perform an analysis to identify an elbow in a curve charted based on a number of clusters versus a percentage of variance accounted for by the clusters.

Example 84 includes the subject matter of any of Examples 59-83, and wherein to flag each mapped individual that satisfies a distance threshold from a corresponding centroid comprises to flag each mapped individual satisfying a defined Mahalanobis distance from the corresponding centroid.

Example 85 includes the subject matter of any of Examples 59-84, and wherein the instructions further cause the compute device to obtain feedback indicative of an accuracy of the compute device; and store the feedback for future identification of individuals having the defined characteristic.

Example 86 includes the subject matter of any of Examples 59-85, and wherein to obtain feedback comprises to obtain feedback indicative of individuals having the defined characteristic that were not flagged by the compute device as having the defined characteristic.

Example 87 includes the subject matter of any of Examples 59-86, and wherein to obtain feedback comprises to obtain feedback indicative of individuals that were flagged by the compute device as having the defined characteristic and that were later determined to not actually have the defined characteristic.

1. A compute device comprising:
circuitry configured to:
obtain financial account data pertaining to multiple individuals;
define a coordinate space in which to map the individuals associated with the obtained data, including performing a dimensionality reduction on the obtained data;
map each individual according to the coordinate space;
define one or more centroids in the coordinate space as a function of features of individuals previously flagged as having a defined characteristic; and
flag each mapped individual that satisfies a distance threshold from a corresponding centroid in the coordinate space or that is within a defined number of closest individuals to the corresponding centroid as having the defined characteristic.

2. The compute device of claim 1, wherein to perform a dimensionality reduction on the obtained data comprises to perform a principal component analysis to identify features that account for the largest amount of variance between individuals in the obtained data.

3. The compute device of claim 1, wherein to flag each mapped individual that satisfies a distance threshold from a corresponding centroid comprises to flag each mapped individual satisfying the distance threshold as a suspected money launderer.

4. The compute device of claim 1, wherein the circuitry is further configured to standardize the obtained data to remove differences in scale by: (i) dividing values represented in the obtained data for each feature by a standard deviation for each feature; and/or (ii) standardizing the data with a correlational matrix.

5. The compute device of claim 1, wherein to define one or more centroids comprises:
(i) defining a centroid for each of multiple nodes; and/or (ii) defining a centroid based on an average of multiple individuals previously flagged as having the defined characteristic.

6. The compute device of claim 1, wherein the circuitry is further configured to perform a clustering analysis for each centroid.

7. The compute device of claim 6, wherein the circuitry is further configured to perform an analysis to identify an elbow in a curve charted based on a number of clusters versus a percentage of variance accounted for by the clusters.

8. The compute device of claim 1, wherein to flag each mapped individual that satisfies a distance threshold from a corresponding centroid comprises to flag each mapped individual satisfying a defined Mahalanobis distance from the corresponding centroid.

9. The compute device of claim 1, wherein the circuitry is further to:
obtain feedback indicative of an accuracy of the compute device;
store the feedback for future identification of individuals having the defined characteristic; and
wherein to obtain feedback comprises: (i) to obtain feedback indicative of individuals having the defined characteristic that were not flagged by the compute device as having the defined characteristic; and/or (ii) to obtain feedback indicative of individuals that were flagged by the compute device as having the defined characteristic and that were later determined to not actually have the defined characteristic.

10. A method comprising:
obtaining, by a compute device, financial account data pertaining to multiple individuals;
defining, by the compute device, a coordinate space in which to map the individuals associated with the obtained data, including performing a dimensionality reduction on the obtained data;
mapping, by the compute device, each individual according to the coordinate space;
defining, by the compute device, one or more centroids in the coordinate space as a function of features of individuals previously flagged as having a defined characteristic; and
flagging, by the compute device, each mapped individual that satisfies a distance threshold from a corresponding centroid in the coordinate space or that is within a defined number of closest individuals to the corresponding centroid as having the defined characteristic.

11. The method of claim 10, wherein performing a dimensionality reduction on the obtained data comprises performing a principal component analysis to identify features that account for the largest amount of variance between individuals in the obtained data.

12. The method of claim 10, wherein flagging each mapped individual that satisfies a distance threshold from a corresponding centroid comprises flagging each mapped individual satisfying the distance threshold as a suspected money launderer.

13. The method of claim 10, further comprising standardizing, by the compute device, the obtained data to remove differences in scale by: (i) standardizing the obtained data comprises dividing values represented in the obtained data for each feature by a standard deviation for each feature; and/or (ii) standardizing the obtained data comprises standardizing the data with a correlational matrix.

14. The method of claim 10, wherein defining one or more centroids comprises: (i) defining a centroid for each of multiple nodes; (ii) defining a centroid based on an average of multiple individuals previously flagged as having the defined characteristic.

15. The method of claim 10, further comprising performing an analysis to identify an elbow in a curve charted based on a number of clusters versus a percentage of variance accounted for by the clusters.

16. The method of claim 10, wherein flagging each mapped individual that satisfies a distance threshold from a corresponding centroid comprises flagging each mapped individual satisfying a defined Mahalanobis distance from the corresponding centroid.

17. The method of claim 10, further comprising:
obtaining, by the compute device, feedback indicative of an accuracy of the compute device; and
storing, by the compute device, the feedback for future identification of individuals having the defined characteristic.

18. The method of claim 17, wherein obtaining feedback comprises: (i) obtaining feedback indicative of individuals having the defined characteristic that were not flagged by the compute device as having the defined characteristic; and/or (ii) obtaining feedback indicative of individuals that were flagged by the compute device as having the defined characteristic and that were later determined to not actually have the defined characteristic.

19. The method of claim 10, wherein obtaining financial account data comprises obtaining data pertaining to individuals that were previously flagged as suspected money launderers.

20. One or more machine-readable storage media comprising a plurality of instructions stored thereon that, in response to being executed, cause a compute device to:
obtain financial account data pertaining to multiple individuals;
define a coordinate space in which to map the individuals associated with the obtained data, including performing a dimensionality reduction on the obtained data;
map each individual according to the coordinate space;
define one or more centroids in the coordinate space as a function of features of individuals previously flagged as having a defined characteristic; and
flag each mapped individual that satisfies a distance threshold from a corresponding centroid in the coordinate space or that is within a defined number of closest individuals to the corresponding centroid as having the defined characteristic.
